(19) United States
(12) Patent Application Publication
(10) Pub. No.: US 2026/0121850 A1
(43) Pub. Date: Apr. 30, 2026

(54) Systems and Methods for Scalable Secure Multi-Party Computation with Configurable Party Participation

(71) Applicant: Enveil, Inc., Fulton, MD (US)

(72) Inventor: Ryan Carr, Fulton, MD (US)

(21) Appl. No.: 19/431,925

(22) Filed: Dec. 23, 2025

Related U.S. Application Data
(63) Continuation-in-part of application No. 18/754,085, filed on Jun. 25, 2024, now Pat. No. 12,537,673.
(60) Provisional application No. 63/529,667, filed on Jul. 28, 2023.

(51) Int. Cl. H04L 9/08; H04L 9/06

(52) U.S. Cl. CPC H04L 9/088; H04L 9/0631

(57) ABSTRACT

A method and system for secure multi-party computation reduces the number of parties participating in each partition of a computation circuit from a total party count N to one plus a checkpoint key share count. A controller partitions an overall secure multi-party computation circuit such that parts of the circuit that directly use each private input value are partitioned separately. For each partition, the controller assigns an input-providing computer and a plurality of key holder computers. Within each secure multi-party computation protocol instance, shares of a secret key are generated and distributed among the key holder computers. The partition output is encrypted using the secret key to produce encrypted checkpoint data, which is written to external storage. A subsequent protocol instance decrypts the checkpoint data using the key shares, enabling continued computation with a different input-providing computer while maintaining security through distributed key share custody.

### CROSS REFERENCE TO RELATED APPLICATIONS

This application is a continuation-in-part of U.S. patent application Ser. No. 18/754,085, filed on Jun. 25, 2024, which claims the benefit and priority of U.S. Provisional Application Ser. No. 63/529,667, filed on Jul. 28, 2023, which are hereby incorporated by reference herein in their entireties, including all references and appendices cited therein.

### FIELD

The present disclosure pertains to secure multi-party computation (SMPC) systems and methods, and more particularly to distributed SMPC architectures and techniques for improving computational scalability and performance in protocols involving multiple participating parties.

### SUMMARY

One general aspect includes a method for secure multi-party computation with reduced party participation. The method includes receiving, by a controller computer, a computation structure, a total party count N, and a plurality of private input values, wherein each private input value of the plurality of private input values corresponds to a respective participating party of a plurality of participating parties. The method includes receiving, by the controller computer, a designation of a checkpoint key share count. The method includes partitioning, by the controller computer, an overall secure multi-party computation circuit into a plurality of partitions such that parts of the circuit that directly use each private input value are partitioned separately from one another. The method includes assigning, by the controller computer, a first participating party of the plurality of participating parties as an input-providing party for a first partition of the plurality of partitions.

The method includes assigning, by the controller computer, a number of additional participating parties of the plurality of participating parties equal to the checkpoint key share count as key holder parties for the first partition, wherein a total number of parties assigned to the first partition equals one plus the checkpoint key share count. The method includes initiating, by the controller computer, execution of the first partition as a secure multi-party computation protocol instance with a party subset comprising the input-providing party and the key holder parties. The method includes generating, within the secure multi-party computation protocol instance, shares of a secret key, wherein the shares of the secret key are distributed among the key holder parties.

The method includes encrypting, by the controller computer, a partition output of the first partition using the secret key to produce encrypted checkpoint data. The method includes writing, by the controller computer, the encrypted checkpoint data to storage external to the secure multi-party computation protocol instance. Other embodiments of this aspect include corresponding computer systems, apparatus, and computer programs recorded on one or more computer storage devices, each configured to perform the actions of the method.

One general aspect includes a system for partitioned secure multi-party computation. The system includes a plurality of computers, each computer of the plurality of computers associated with a respective participating party and configured to contribute a respective private input value to a computation. The system includes a checkpoint storage configured to store encrypted checkpoint data. The system includes a controller configured to partition an overall secure multi-party computation circuit into a plurality of partitions, each partition of the plurality of partitions involving a party subset of the plurality of computers. The controller is configured to, for a first partition of the plurality of partitions, designate a first computer of the plurality of computers as an input-providing computer that contributes a first private input value to the first partition and designate a plurality of key holder computers from the plurality of computers.

The controller is configured to execute the first partition as a secure multi-party computation protocol instance with the party subset comprising the input-providing computer and the plurality of key holder computers. The controller is configured to generate, within the secure multi-party computation protocol instance, shares of a secret key distributed among the plurality of key holder computers. The controller is configured to encrypt a partition output of the first partition using the secret key to produce the encrypted checkpoint data. The controller is configured to write the encrypted checkpoint data to the checkpoint storage. Other embodiments of this aspect include corresponding methods, apparatus, and computer programs recorded on one or more computer storage devices, each configured to perform the actions of the system.

One general aspect includes a method for managing checkpoint key shares in secure multi-party computation. The method includes receiving, by a controller, a checkpoint key share count and a plurality of private input values from a plurality of computers. The method includes configuring, by the controller, a secure multi-party computation protocol instance for a current partition, wherein the configuring comprises designating a plurality of key holder computers from the plurality of computers, a number of the plurality of key holder computers equaling the checkpoint key share count.

The method includes initiating, by the controller, execution of the secure multi-party computation protocol instance. The method includes generating, within the secure multi-party computation protocol instance, a respective key share for each key holder computer of the plurality of key holder computers, wherein no single key holder computer possesses a complete secret key. The method includes combining, within the secure multi-party computation protocol instance, the respective key shares to form the complete secret key. The method includes encrypting, by the controller, a partition output of the current partition using the complete secret key to produce encrypted checkpoint data.

The method includes writing, by the controller, the encrypted checkpoint data to storage external to the secure multi-party computation protocol instance. The method includes initiating, by the controller, a subsequent secure multi-party computation protocol instance with the plurality of key holder computers. The method includes decrypting, within the subsequent secure multi-party computation protocol instance, the encrypted checkpoint data using the respective key shares. Other embodiments of this aspect include corresponding computer systems, apparatus, and computer programs recorded on one or more computer storage devices, each configured to perform the actions of the method.

### BRIEF DESCRIPTION OF THE DRAWINGS

FIG. 1A illustrates arithmetic circuits and their composition to compute a dot product of vectors.

FIG. 1B illustrates an arithmetic circuit.

FIG. 1C illustrates the combination of multiple dot product and sum circuits for distributed computation.

FIG. 2 illustrates an architecture of a system including controllers, servicers, and communication channels between them.

FIG. 3 illustrates a flowchart of the method for orchestrating distributed secure multi-party computations.

FIG. 4 illustrates a flowchart of the method for enhancing computational power in a distributed secure multi-party computation system.

FIG. 5 illustrates a diagrammatic representation of an example machine in the form of a computer system.

FIG. 6 illustrates a standard secure multi-party computation protocol with multiple participating parties computing an aggregate result from private input values.

FIG. 7 illustrates a partitioned secure multi-party computation protocol with checkpoint key shares enabling reduced party participation per partition.

FIG. 8 illustrates a flowchart of a method for reducing party count in many-party secure multi-party computations using checkpoint encryption.

FIG. 9 illustrates a flowchart of a method for checkpoint key share generation and management within an SMPC protocol.

FIG. 10 illustrates a flowchart of a method for party assignment across partitions including key holder rotation.

FIG. 11 illustrates a flowchart of an alternative method using threshold encryption for mid-protocol party switching.

### DETAILED DESCRIPTION OF EXAMPLE EMBODIMENTS

### Overview

Secure Multi-Party Computation (SMPC) protocols are a family of cryptographic protocols that allow two or more participating parties to jointly compute some function depending upon inputs from each party and provide the output of the function to one or more participants. The SMPC protocol protects the inputs of some or all participating parties, such that no other participating party is able to learn anything about the protected inputs. Only the final output of the computed function is accessible, and only to the specific parties agreed to at the start of the protocol. Different SMPC schemes exist that support different types of functions: the Yao Garbled Circuits scheme support any function that can be expressed as a binary circuit of AND, OR, and NOT gates connected by wires carrying true or false values, while the Arithmetic Secret Sharing scheme and Boolean Secret Sharing scheme support functions that can be expressed as a circuit of arithmetic (i.e., addition and multiplication) or Boolean (i.e., AND, OR, and NOT) operations over values in some input domain. So-called “ABY” schemes also exist, which support computations that are a combination of functions supported by the Arithmetic Secret Sharing, Boolean Secret Sharing, and Yao Garbled Circuits schemes and contain sub-protocols for switching between these schemes.

SMPC protocol schemes discussed above allow the function to be computed by the protocol to be expressed as a “circuit” of operations of the supported types, and running the protocol to compute the function over the participating parties'inputs involves executing one or more cryptographic sub-protocols for each element in the circuit. Because each element in the circuit must be one of the primitive computation types supported by the protocol (i.e., a logical gate, arithmetic addition or multiplication, or Boolean operation), circuit for complex computations, such as analytics over large scale data sets or machine learning computations, can easily require millions or even billions of circuit elements and corresponding cryptographic sub-protocols to execute. The speed of each subprotocol execution is typically bounded by the availability of computation resources and/or network bandwidth between the parties participating in the protocol. Complex computations can therefore be impractical to execute using standard SMPC protocols, which operate using a single process for each participating party and a single network connection between parties

The systems and methods of the present disclosure use SMPC to compute large, complex functions by distributing the protocol across multiple computers administered by each participating party. This increases the amount of computational power available to all parties and increases the amount of network bandwidth between parties, which increases the throughput of SMPC computations and makes larger, more complex computations possible. In order to adapt the standard SMPC protocol into one that can run distributed on a cluster, several new techniques must be used. These can be categorized into circuit partitioning, protocol orchestration, and failure recovery.

It will be understood that with respect to the general aspects of distributed secure multi-party computation, there are a plurality of different, and sometimes conflicting meanings of “distributed. ” Some systems appear to focus on distributing the offline generation of cryptographic primitives required by the computation, and not parallelizing the execution of the protocol itself. However, the systems and methods of the present disclosure can be configured to analyze the structure of the computation and determine which parts can be parallelized.

In order for distributed processing of SMPC circuits to benefit performance, the computers involved in the processing for each party must handle different parts of the overall SMPC circuit. The process of breaking up the overall circuit into parts that can be processed separately is called “partitioning,” and the separate pieces are called “partitions. ” Any inputs or outputs of circuit elements that cross partition boundaries will require communication between the computers processing those partitions, which carries performance penalties. The partitions should also have similar size to one another, in order to balance the workload performed by the different computers. The objectives of computing a circuit partitioning are therefore to keep the number of inputs and outputs that cross partition boundaries low relative to the overall size of the circuit, while also ensuring that the different partitions have similar size. Finding an optimal partition that maximizes both of these objectives is a computationally hard (i.e., NP-complete) problem, and therefore any system that needs to compute such partitions will be based on heuristics.

The systems and methods of the present disclosure are pre-configured with “building blocks,” which are circuits of supported SMPC operations that execute common computational functions (e.g., floating point arithmetic circuits for a Yao Garbled Circuit, or a vector dot product function for an arithmetic circuit) whose number of internal SMPC operations is high relative to its number of input and output values. The overall desired circuit is constructed from these building blocks whenever possible, and the system permits new building blocks to be specified by users for desired operations that are not already included in a building block. The system represents the overall SMPC circuit as a network of these building blocks, with edges connecting blocks that have inputs and outputs to one another.

The systems and methods of the present disclosure further address performance limitations arising in SMPC protocols involving more than two participating parties. Many SMPC protocols that support three or more parties require communication that scales super-linearly in the number of parties. Protocols requiring O(N²) communication to execute a computation involving N parties result in significantly degraded performance as party count increases. The present disclosure provides techniques for enabling protocols of three or more parties to execute faster by reducing the number of parties involved in any individual partition of the overall computation circuit.

The reduction in party count per partition is achieved through a checkpoint key share mechanism. A user designates a checkpoint key share count (CKSC) representing the number of key holder parties that will generate shares of a secret key used to encrypt partition outputs. For each partition, the number of active parties is reduced to one plus the CKSC, where the one party is the party providing input to that partition and the additional parties are the designated key holders. The key holder parties generate shares of a secret key within the SMPC protocol execution, and this key is used to encrypt the output of the partition as checkpoint data. The encrypted checkpoint data is written to storage, and a subsequent SMPC protocol instance is initiated for the next partition with a different party subset that includes the key holder parties. The checkpoint data is decrypted inside the subsequent SMPC protocol using the key shares, and computation continues. Because decryption requires all key shares, the checkpoint data cannot be accessed unless all key holder parties collude. This technique reduces communication complexity from O(N²) to O((1+CKSC)²), providing significant performance improvements while maintaining security against collusion of fewer than all key holders. The key holder parties may remain the same across consecutive partitions, or the system may rotate the set of key holder parties through all available parties as different partitions are executed.

### EXAMPLE EMBODIMENTS

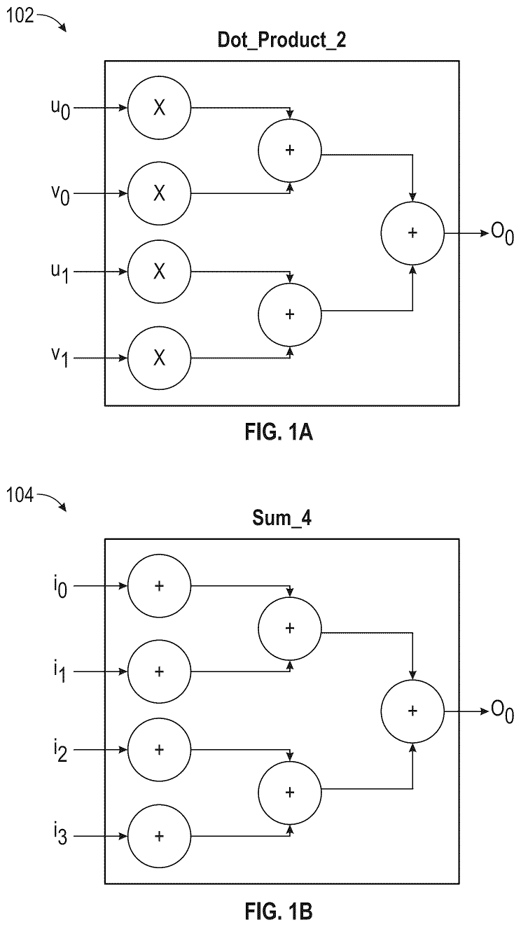

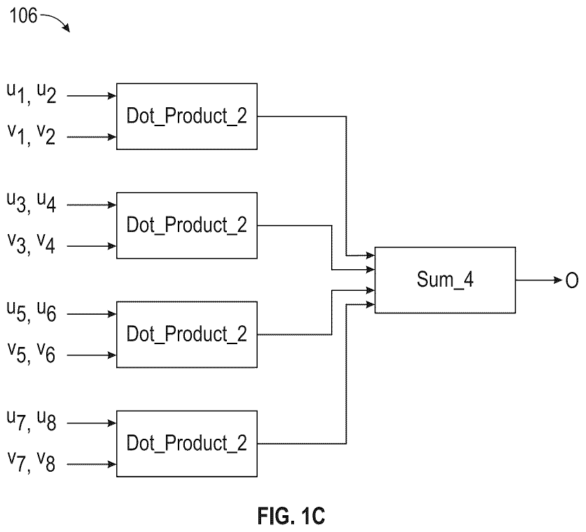

FIG. 1A illustrates a building block, arithmetic circuit 102, for computing the dot product of two vectors of length two. FIG. 1B illustrates a building block, arithmetic circuit 104, for computing the sum of four numbers. FIG. 1C illustrates a circuit diagram that composes these two building blocks to compute the dot product of vectors of length eight.

The arithmetic circuit 102 in FIG. 1A includes several components and operations. The inputs to the arithmetic circuit 102 are labeled as u0, u1, v0, and v1, which represent the elements of two vectors. Specifically, u0 and u1 are the components of the first vector, while v0 and v1 are the components of the second vector. These inputs are used in arithmetic operations within the block to compute the dot product.

Within the arithmetic circuit 102, circles labeled with X and + represent multiplication and addition operations, respectively. The circles with X indicate where the corresponding elements of the vectors are multiplied together. For instance, one X operation multiplies u0 by v0, and another X operation multiplies u1 by v1. These multiplication operations are used for calculating the intermediate products of the dot product computation.

After these multiplications, the results are passed to the circles labeled with +, which perform the addition operations. The purpose of these addition operations is to sum the products obtained from the multiplication operations. Specifically, the outputs of the multiplication circles are added together to compute the final dot product: (u0*v0)+(u1*v1). This sum is the ultimate result of the arithmetic circuit 102, representing the dot product of the two input vectors.

The arithmetic circuit 104 in FIG. 1B is designed to compute the sum of four numbers. The inputs to this block are typically labeled i0, i1 i2, and i3 representing the four numbers to be summed.

Within the arithmetic circuit 104, the circles labeled with + indicate addition operations. These circles perform the arithmetic addition necessary to compute the sum of the four input numbers. Specifically, each + circle represents the addition of two numbers at a time. For example, the first addition operation might add i0 and i1 and the second addition operation might add i3 and i4. The results of these two additions are then fed into another addition operation, which sums these intermediate results to produce a final output (i0+i1)+(i2+i3).

FIG. 1C illustrates an arithmetic operation 106 combining multiple “dot_product_2” blocks with a “sum_4” block. Each “dot_product_2” block computes the dot product of two pairs of input vectors. Specifically, the inputs u1, u2 and v1, v2 are fed into the first “dot_product_2” block, u3, u4 and v3, v4 into the second, u5, u6 and v5, v6 into the third, and u7, u8 and v7, v8 into the fourth. The outputs from these “dot_product_2” blocks, which are the individual dot products, are then directed into the “sum_4” block.

The “sum_4” block takes these four dot products as its inputs and performs an addition operation to produce a single output. This hierarchical structure enables the computation of a more complex mathematical operation by breaking it down into simpler, manageable components. The design leverages the efficiency of smaller arithmetic units to handle larger calculations in a distributed manner, which is essential for applications in SMPC systems.

This hierarchical approach to addition ensures that the summation process is both efficient and manageable within the circuit's architecture. The use of multiple addition operations allows the block to handle the addition of four numbers in a structured manner, ensuring accurate and secure computation within the SMPC framework.

Because each building block contains a large number of internal operations relative to its input and output values, treating each such block as a circuit partition will provide reasonably good performance. An example system may also choose to use other heuristics to combine multiple blocks into one circuit partition.

In a distributed SMPC protocol, each participating party has several computers assigned to work on the protocol. These computers can be provisioned ahead of time or provisioned on-demand as the protocol starts (e.g., using a technology like Kubernetes or any container service). In order to realize the performance benefits of having multiple computers per party, these computers must be assigned separate pieces of the overall SMPC protocol, in a way that minimizes computation overlap and exchange of data between computers owned by the same participating party. The system is configured to dynamically provision additional servicer computers on-demand as the protocol starts. This dynamic provisioning enhances computational resource availability and allows the system to scale efficiently in response to the computational demands of the SMPC process. In some embodiments, each computer in the system is configured to handle computations on private data within a secure environment. This secure environment, often referred to as a secure enclave, ensures the integrity and confidentiality of the data being processed. Dynamically provisioning additional servicer computers on-demand as the protocol starts enhances computational resource availability. This feature allows the system to scale efficiently in response to the computational demands of the SMPC process. When the protocol begins, additional servicer computers can be provisioned dynamically, ensuring that sufficient computational resources are available to handle the workload. This dynamic provisioning is essential for maintaining optimal performance and adapting to varying computational requirements. Grouping servicer computers with similar computational capabilities and network bandwidth optimizes the execution of circuit partitions. By assigning servicer computers with comparable performance characteristics to the same tasks, the system ensures that the execution of circuit partitions is balanced and efficient. This grouping reduces the likelihood of bottlenecks caused by disparities in computational power or network speed among the servicer computers, leading to more consistent and reliable performance.

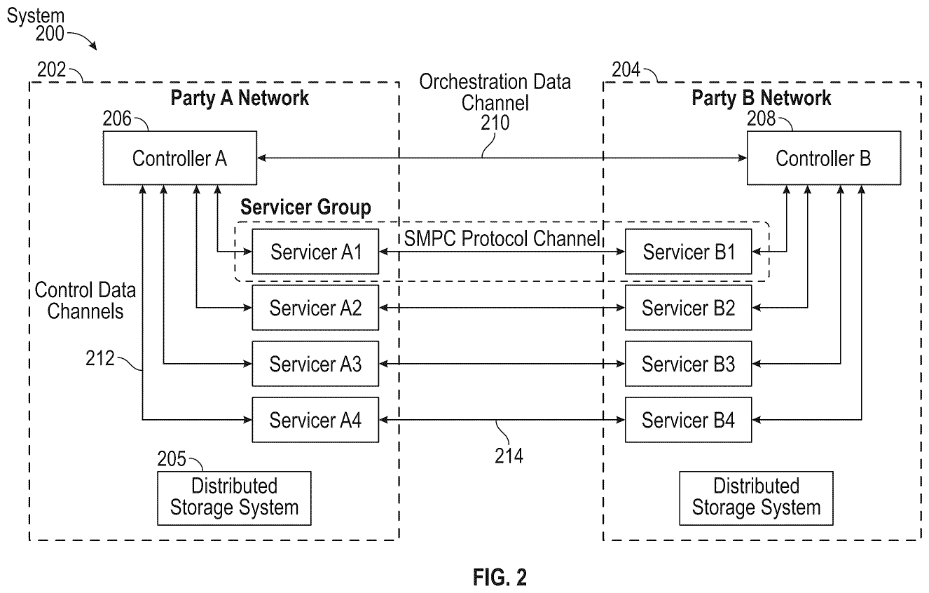

Turning now to FIG. 2, in this architecture, an example SMPC system (hereinafter “system 200”) is illustrated. One computer per party has the role of “Controller,” while all other computers are as “Servicers.” In this example, there are two networks such as Party A Network 202 and Party B Network 204. Each of the networks includes a controller, such as Controller A 206 of Party A Network 202 and Controller B 208 of Party B Network 204.

An orchestration data channel 210 can be established between Controller A 206 and Controller B 208. The orchestration data channel 210 facilitates communication between Controller A 206 and Controller B 208. This channel is responsible for coordinating the actions of the controllers, enabling them to synchronize the operations of their respective servicers. Through orchestration data channel 210, the controllers exchange information regarding the status of circuit partitions, the availability of computational resources, and any necessary adjustments to the execution of the SMPC protocol. This ensures that all participating parties remain aligned and can dynamically respond to changes in the computation environment, such as network bandwidth fluctuations or computational load balancing. In one example, the Party A Network 202 includes several servicer nodes such as Servicer A1-A4.

The Servicers A1-A4 are each individually communicatively coupled to Controller A 206 through Control Data Channels, such as Control Data Channel 212. SMPC control data channels, such as SMPC control data channel 214, can communicatively couple servicers between Party A Network 202 and Party B Network 204. For example, SMPC control data channel 214 can be established between Servicer A4 of Party A Network 202 and Servicer B4 of Party B Network 204. In some implementations, communication between the controller computer and the multiple computers is encrypted using secure communication protocols. These protocols ensure that the data exchanged remains confidential and its integrity is protected against unauthorized access. As noted above, the system 200 includes the distributed storage system 205 integrated with the servicer nodes. The distributed storage system 205 enables state and output data to be stored and retrieved efficiently, facilitating data recovery and continuity of operations across the network. Thus, critical data and computation states can be stored and retrieved as need. In other words, the system incorporates redundancy by maintaining backup copies of critical data and computation states across the multiple computers, enabling seamless recovery and continuation of the SMPC process upon a failure.

When the parties agree to begin a computation using SMPC, the parties specify the overall structure of the computation (i.e., whether it is an analytic, machine learning training, and so forth), the number of secret inputs per party, and each party secretly determines what its inputs to the computation will be. The controller in one party (agreed upon by all parties ahead of time) serves as the “main controller” for the protocol, and contacts all other controllers to receive the list of servicers available to each party, along with metadata about their location, network bandwidth availability, and computational capabilities. The main controller then constructs groups of servicers, called servicer groups, comprising of one servicer from each party. Servicer grouping can be done at random, or can attempt to group servicers with similar location, network bandwidth, or computational capabilities together.

Each servicer group is capable of executing a circuit partition and exchanging data with other servicer groups (in this case, each servicer in the group exchanges data only with the servicer belonging to the same party in the other servicer group). The controller computer includes a module that dynamically adjusts the size of the partitions based on real-time performance metrics of each participating computer. This adjustment ensures that the computational load is balanced across the distributed system (e.g., system 200), optimizing the performance and efficiency of the SMPC process.

The main controller, in this example Controller A 206, then orchestrates the overall protocol by maintaining an ordering of circuit partitions and an assignment of circuit partitions to Servicers A1-A4. A circuit partition is eligible for execution if all of its input partitions have been computed. Initially only the data input partitions are eligible for execution; however, as these are completed, other partitions will become eligible.

With respect to failure recovery, while the probability of failure of a single computer at any given time is low, in distributed computing it is a well-known problem that as the number of computers involved in the system 200 increases, the probability of at least one failure of any computer rises quickly. The systems and methods of the present disclosure can recover from failures of Servicers 1-4 and Controller A 206 and Controller B 208. The distributed storage system 205 (e.g., Hadoop HDFS) runs alongside the servicer processes on participating computers. The distributed storage system 205 replicates data written to it across multiple participating computers, so that the data is still available in the event of a failure of one computer. As Servicers A1-A4 execute circuit partitions, they write state information and output information (for completed partitions) to the distributed storage system 205.

In the event of a servicer failure, Controller A 206 will provision a new servicer process on one of the participating computers (or requisition a new computer if a dynamic provisioning system is used). This new servicer will use the distributed storage system 205 to read the last known state data written by the failed servicer; this will allow the servicer to restart processing the most recent circuit partition and serve output data from any completed circuit partitions to other requesting Servicers A1-A4, and the system 200 can return to normal operation. In the event of a failure, the system ensures continuity and resilience by including the re-assignment of the circuit partitions and data recovery from the distributed storage system 205.

When a failure is detected, the system 200 dynamically re-assigns the affected circuit partitions to other available servicer nodes. This re-assignment process leverages the distributed storage system 205, where state information and outputs of completed partitions are persistently stored. The reassigned servicer nodes access this data to recover the last known state, allowing them to resume processing with minimal disruption. This approach enhances the fault tolerance and robustness of the distributed SMPC protocol, ensuring that computations can proceed even in the face of individual node failures.

This process minimizes data loss and reduces the time required for recovery, thereby enhancing the overall robustness and efficiency of the SMPC system. The checkpointing intervals and the specific state information to be saved can be configured based on the computational workload and performance requirements, ensuring an optimal balance between redundancy overhead and recovery speed.

The system can support resilience to failure of Controller A 206 by provisioning a backup controller for each party. While the primary controller remains functional, it sends all of its state data to the backup controller, which uses the data to maintain an equivalent state of the system. If the backup controller detects a failure of the primary controller, it sends a notification to all Servicers A1-A4 that it is taking over the role of primary controller and provisions a new backup controller process on one of the participating computers (or requisitions a new computer if a dynamic provisioning system is used). Maintaining a backup controller for each party is crucial for system reliability. The backup controller synchronizes state data with the primary controller, ensuring that it has the most up-to-date information. In the event of a primary controller failure, the backup controller can seamlessly take over operations, minimizing disruption and maintaining the integrity of the computation. This synchronization involves regular updates and checks to keep the backup controller in sync with the primary controller's state.

The Servicers A1-A4 reply to the notification with their last known state data, and the new primary controller reconciles this with the last information it received from the failed controller, notifying the servicers to re-run any circuit partitions for which the state data is inconsistent. After this process is complete, the system can return to normal operation. In one embodiment, the controller computer employs predictive algorithms to foresee potential system failures. By anticipating these failures, the controller can proactively reassign tasks to prevent disruption of the SMPC process and maintain system stability.

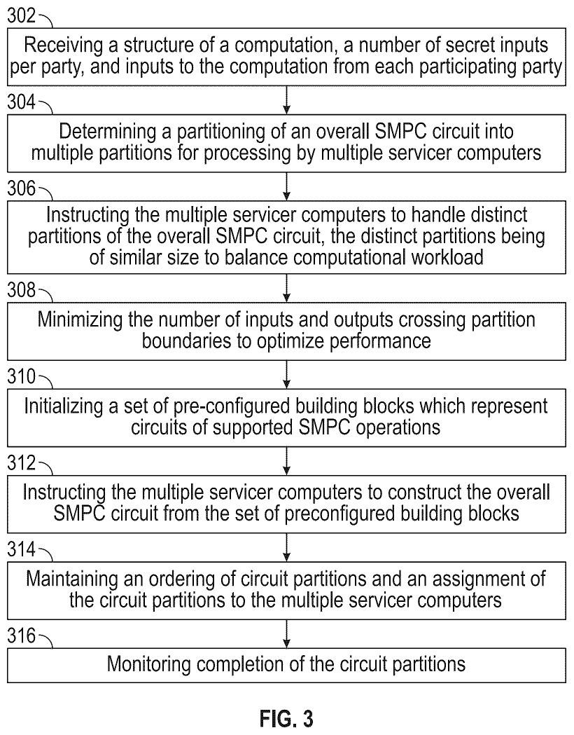

FIG. 3 is a flowchart of an example method of the present disclosure. The method is directed to orchestrating distributed secure multi-party computations (SMPC), executed by a controller computer system. In some embodiments, the method includes a step 302 of receiving a structure of a computation, a number of secret inputs per party, and inputs to the computation from each participating party. In this step, the main controller gathers the overall structure of the computation, specifying the type of computation (e.g., analytics, machine learning training), the number of secret inputs from each party, and the particular inputs each party will provide. This ensures that all necessary data and computation requirements are clearly defined before the protocol starts.

In one embodiment, the method includes a step 304 of determining a partitioning of an overall SMPC circuit into multiple partitions for processing by multiple servicer computers. In this step, the main controller analyzes the overall SMPC circuit and divides it into smaller, manageable partitions. This partitioning allows the computation to be distributed across multiple servicer computers, optimizing resource utilization and efficiency.

In some embodiments, the method includes a step 306 of instructing the multiple servicer computers to handle distinct partitions of the overall SMPC circuit, the distinct partitions being of similar size to balance computational workload. The main controller issues instructions to the servicer computers, ensuring that each servicer handles a partition of the SMPC circuit. The partitions are designed to be of similar size to evenly distribute the computational workload and prevent any single servicer from being overloaded.

In various embodiments, the method includes a step 308 of minimizing the number of inputs and outputs crossing partition boundaries to optimize performance. To enhance the efficiency of the distributed computation, the method involves reducing the interactions between partitions. By minimizing the number of inputs and outputs that cross partition boundaries, the method reduces communication overhead and improves overall performance.

The method includes a step 310 of initializing a set of pre-configured building blocks which represent circuits of supported SMPC operations. The main controller initializes pre-configured building blocks that represent common SMPC operations. These building blocks serve as fundamental components for constructing the overall SMPC circuit, facilitating easier and faster setup of complex computations.

According to some embodiments, the method includes a step 312 of instructing the multiple servicer computers to construct the overall SMPC circuit from the set of pre-configured building blocks. Using the pre-configured building blocks, the servicer computers are instructed to assemble the overall SMPC circuit. This approach streamlines the construction process and ensures that the circuit is built correctly and efficiently.

In one embodiment, the method includes a step 314 of maintaining an ordering of circuit partitions and an assignment of the circuit partitions to the multiple servicer computers. The main controller maintains a systematic ordering of the circuit partitions and assigns them to the servicer computers. This organizational structure helps in tracking the progress of each partition and ensures that the computation proceeds in an orderly manner.

In various embodiments, the method includes a step 316 of monitoring completion of the circuit partitions. The main controller continuously monitors the progress of the servicer computers as they work on their respective partitions. This monitoring helps in identifying any issues or delays in real-time and allows for prompt corrective actions to ensure timely completion of the computation.

In some embodiments, the method includes a step 318 of updating the set of eligible circuit partitions. As partitions are completed, the main controller updates the set of eligible circuit partitions, making new partitions available for execution. This dynamic updating process ensures that the computation proceeds smoothly and that resources are optimally utilized throughout the execution of the SMPC protocol.

In some embodiments, a system incorporates a distributed storage system to store state and output information, which is crucial for data recovery in case of failures. For instance, consider a scenario where a servicer computer fails during the computation process. In such a case, the system provisions a new servicer computer to replace the failed one. The new servicer reads the last known state data from the distributed storage system, allowing it to resume processing from where the previous servicer left off, thus preventing significant interruptions. Additionally, the system dynamically reassigns any unfinished circuit partitions to other available servicer computers based on the most recent state data. This approach ensures that the computation can proceed smoothly and efficiently, even when individual servicers encounter failures.

To enhance computational resource availability, the system includes a feature for dynamically provisioning additional servicer computers on demand. For example, if the computational workload increases unexpectedly, the system can automatically allocate more servicer computers to handle the additional tasks. This capability ensures that the system can scale efficiently and provide the necessary resources to manage increased workloads, maintaining optimal performance.

The system groups servicer computers with similar computational capabilities and network bandwidth to optimize the execution of circuit partitions. By matching computers with comparable performance characteristics, the system ensures that computational tasks are executed efficiently. For instance, if two servicer computers have similar processing power and network speed, they can be grouped together to handle partitions of the SMPC circuit, reducing the likelihood of bottlenecks caused by disparities in processing power or network speed.

The step of monitoring the completion of circuit partitions involves continuously tracking the progress of each partition. The system detects any failures or delays in the completion of assigned partitions and promptly reassigns any unfinished partitions to other available servicer computers. For example, if a servicer computer experiences a delay or failure while processing a partition, the system can quickly reassign that partition to another servicer computer to ensure timely completion of the computation. This proactive approach helps maintain overall system performance and reliability.

The system maintains a backup controller computer for the primary controller computer. State data is synchronized between the primary and backup controllers, ensuring the backup is always up-to-date. In the event of a failure of the primary controller, the backup controller takes over operations seamlessly. For instance, if the primary controller fails, the backup controller will automatically assume control and notify the remaining servicer computers of the switch. The servicer computers will then continue normal operations based on the synchronized state data, minimizing any disruption caused by the failure.

The step of updating the set of eligible circuit partitions involves re-evaluating partition dependencies and making newly completed partitions eligible for subsequent computations. This dynamic updating process ensures that the computation proceeds efficiently. For example, as each partition of the SMPC circuit is completed, the system re-evaluates the dependencies and updates the list of eligible partitions, allowing the computation to continue smoothly and ensuring that resources are optimally utilized throughout the execution of the SMPC protocol.

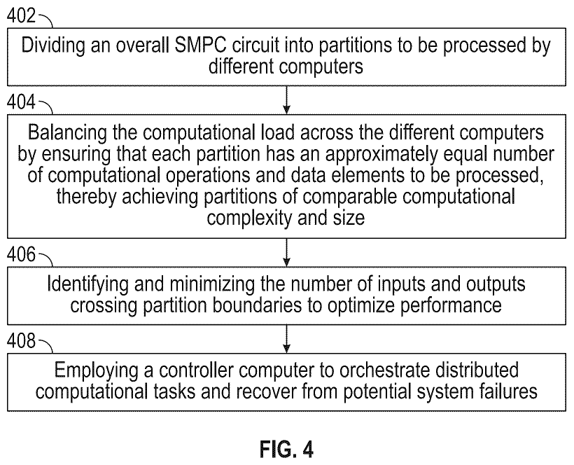

FIG. 4 is a flowchart of an example method of the present disclosure. In some embodiments, the method includes a step 402 of dividing an overall SMPC circuit into partitions to be processed by different computers. This step involves analyzing the SMPC circuit and segmenting it into smaller partitions that can be distributed among multiple computers. This division allows the workload to be shared, making the computation more efficient and manageable.

According to some embodiments, the method includes a step 404 of balancing the computational load across the different computers by ensuring that each partition has an approximately equal number of computational operations and data elements to be processed, thereby achieving partitions of comparable computational complexity and size. This step ensures that no single computer is overburdened while others are underutilized, promoting an even distribution of the computational tasks.

In various embodiments, the method includes a step 406 of identifying and minimizing the number of inputs and outputs crossing partition boundaries to optimize performance. By reducing the data exchange between partitions, this step aims to enhance the efficiency of the computation process, decreasing latency and improving overall performance.

In some embodiments, the method includes a step 408 of employing a controller computer to orchestrate distributed computational tasks and recover from potential system failures. The controller computer coordinates the distributed tasks, assigns partitions to different computers, and manages recovery protocols in case of any system failures, ensuring the continuity and reliability of the computation.

To optimize performance, the method includes dividing the overall SMPC circuit into partitions while minimizing inter-partition communication. This approach reduces the communication overhead, enhancing the efficiency of the SMPC process. By analyzing the circuit and its data dependencies, the system can create partitions that require minimal data exchange across boundaries, optimizing the performance of distributed computations. Minimizing inter-partition communication is essential for optimizing performance in SMPC systems. By reducing the amount of data exchanged between partitions, the system decreases communication overhead and latency. This optimization is achieved by carefully designing the partitions to limit the number of inputs and outputs that cross partition boundaries. As a result, the overall performance of the distributed computation is significantly improved.

Balancing the computational load involves adjusting the size of the partitions to ensure an even distribution of work across the distributed system. The controller computer continuously monitors performance metrics of each participating computer and dynamically adjusts partition sizes. This prevents any single computer from becoming a bottleneck, ensuring efficient use of resources across the system. Balancing the computational load involves adjusting the size of the partitions to ensure an even distribution of work across the distributed system. The controller computer continuously monitors the performance metrics of each participating computer and dynamically adjusts partition sizes. This proactive adjustment helps prevent any single computer from becoming a bottleneck, ensuring that all available computational resources are utilized effectively and efficiently.

In some instances, the controller computer secures data transmitted between partitions using cryptographic protocols to prevent unauthorized access. These protocols ensure that all data exchanged between partitions remains confidential and its integrity is protected, safeguarding the privacy of the inputs and outputs in the SMPC process. The controller computer secures data transmitted between the partitions using cryptographic protocols to prevent unauthorized access during the computation process. These protocols ensure that all data exchanged between partitions remains confidential and its integrity is protected, safeguarding the privacy of the inputs and outputs in the SMPC process.

In one embodiment, the method employs redundancy and checkpointing techniques to periodically save the state of the computation, allowing for restoration and continuation in case of a failure. Checkpointing involves periodically saving the current state to a distributed storage system, ensuring the system can resume from the last saved state if a failure occurs. This process minimizes data loss and reduces recovery time, enhancing the robustness and reliability of the system.

In various embodiments, the controller computer monitors system performance continuously and reassigns computational tasks as necessary to maintain stability and performance. This reassignment process helps balance the workload and ensures the efficient operation of the SMPC system, preventing any single point of failure from disrupting the overall computation. The controller computer monitors system performance continuously and reassigns computational tasks as necessary to maintain stability and performance. By tracking the status and workload of each servicer computer, the controller can detect imbalances or potential failures early. When such issues are identified, the controller reassigns tasks to ensure that the computational load is evenly distributed and that the system continues to operate smoothly without interruption.

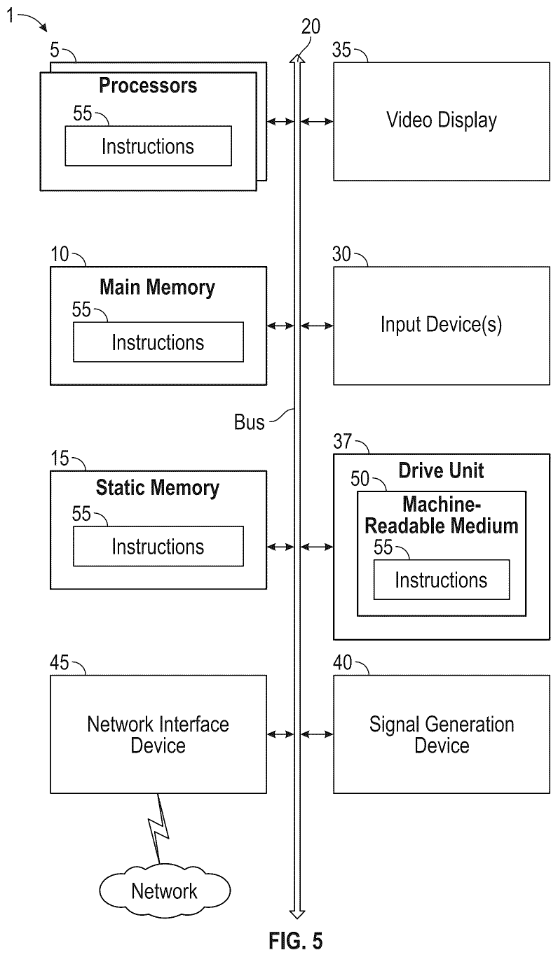

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

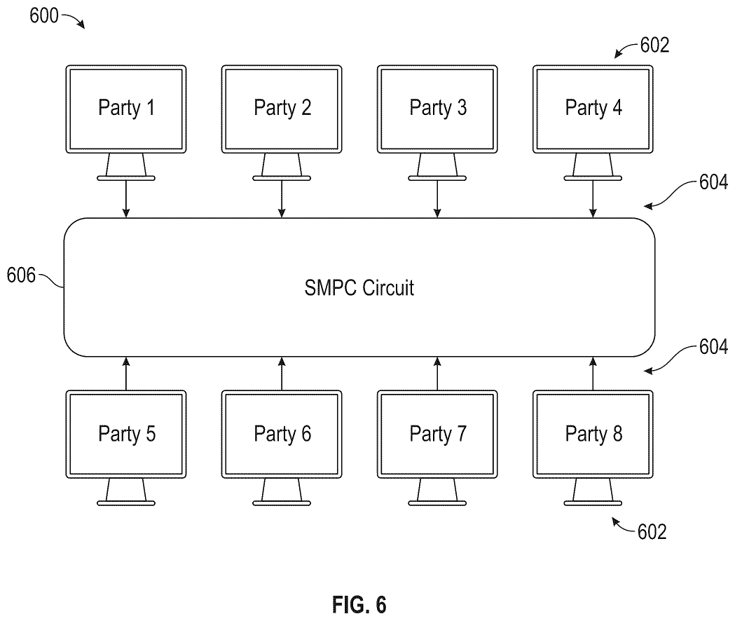

FIG. 6 illustrates a standard secure multi-party computation protocol 600 in which multiple participating parties 602 jointly compute a function depending upon private input values 604 from each party. Each participating party 602 is represented as a computer that provides a respective private input value 604 to an SMPC circuit 606. Arrows extending from each participating party 602 to the SMPC circuit 606 indicate the flow of private input values 604 into the protocol. The SMPC circuit 606 represents a cryptographic protocol that computes an aggregation function, such as calculating an average, over all private input values 604 and produces a computation result. The SMPC circuit 606 protects the private input values 604 such that no participating party 602 is able to learn anything about the private input values 604 of other participating parties 602, and only the final output of the computed function is accessible to the parties agreed upon at the start of the protocol.

Running the protocol to compute the function involves executing one or more cryptographic sub-protocols for each element in the SMPC circuit 606. In this standard configuration, all participating parties 602 must participate simultaneously throughout the entire execution of the SMPC circuit 606. SMPC protocols configured in this manner require communication that scales super-linearly in the total party count N, with many protocols requiring O(N²) communication. The security of the protocol derives from the requirement that all parties participate in the execution of the SMPC circuit 606, providing collusion resistance against up to N-1 colluding parties. However, this configuration creates inherent scalability limitations because each participating party 602 must communicate with all other participating parties 602 throughout execution of the SMPC circuit 606.

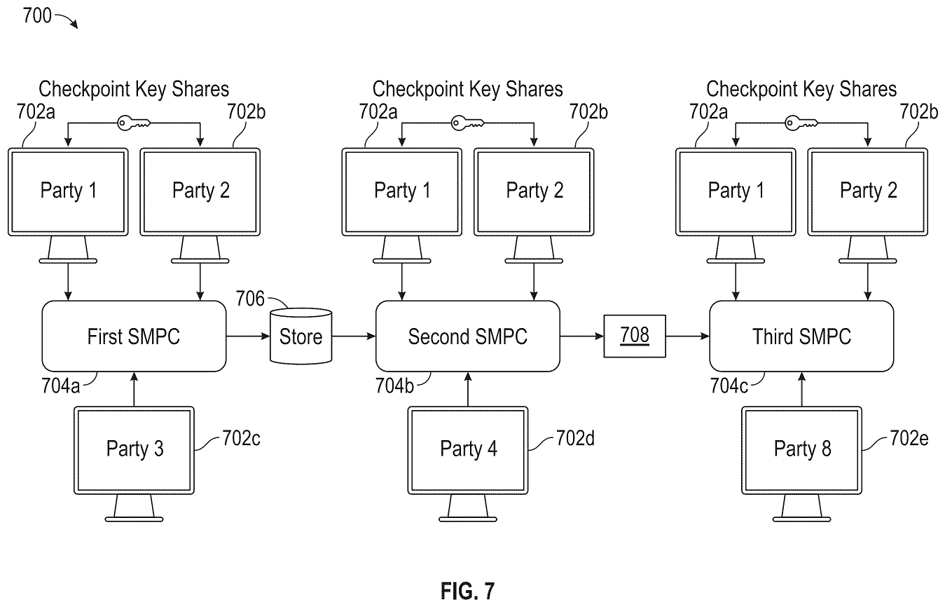

The standard secure multi-party computation protocol 600 of FIG. 6 provides security with up to N-1 colluding parties, meaning that even if only one participating party 602 remains honest, the colluding parties cannot learn any sensitive information provided by the honest party. The partitioned secure multi-party computation protocol 700 of FIG. 7 reduces this collusion tolerance in exchange for improved performance: because decryption of checkpoint data requires all checkpoint key shares, the protocol 700 tolerates up to CKSC-1 colluding key holder parties rather than N-1 colluding parties.

FIG. 7 illustrates a partitioned secure multi-party computation protocol 700 with checkpoint key shares enabling reduced party participation per partition. The protocol 700 is divided into multiple partitions, each involving a party subset of the total participating parties.

A first key holder computer 702a and a second key holder computer 702b serve as key holder computers across all partitions. In the illustrated embodiment, the checkpoint key share count is two, resulting in three participants per partition: the two key holder computers 702a, 702b plus one input-providing computer.

A first partition includes a third computer 702c serving as the input-providing computer for the first partition. The first key holder computer 702a, the second key holder computer 702b, and the third computer 702c collectively execute a first secure multi-party computation protocol instance 704a. The first secure multi-party computation protocol instance 704a performs a sum and count operation on private input values from parties one through three. The partition output is encrypted using a secret key formed from checkpoint key shares held by the key holder computers 702a, 702b and written to checkpoint storage 706.

A second partition includes a fourth computer 702d serving as the input-providing computer for the second partition. The first key holder computer 702a, the second key holder computer 702b, and the fourth computer 702d collectively execute a second secure multi-party computation protocol instance 704b. The second secure multi-party computation protocol instance 704b receives encrypted checkpoint data from checkpoint storage 706. The key holder computers 702a, 702b provide their checkpoint key shares for decryption within the second secure multi-party computation protocol instance 704b. The second secure multi-party computation protocol instance 704b decrypts the checkpoint data, adds the private input value from the fourth computer 702d to the sum and count, encrypts the updated sum and count using the secret key, and in some instances, writes the updated encrypted checkpoint data to checkpoint storage 706.

This pattern repeats for additional computers serving as input-providing computers in successive partitions, as indicated by a repeat block 708 representing partitions for parties five through seven. Each successive partition receives encrypted checkpoint data from checkpoint storage 706, decrypts the data using the checkpoint key shares, incorporates a private input value from the respective input-providing computer, encrypts the updated partition output, and writes the updated encrypted checkpoint data to checkpoint storage 706.

A final partition includes an eighth computer 702e serving as the input-providing computer for the final partition. The first key holder computer 702a, the second key holder computer 702b, and the eighth computer 702e collectively execute a final secure multi-party computation protocol instance 704c. The final secure multi-party computation protocol instance 704c receives encrypted checkpoint data from checkpoint storage 706. The key holder computers 702a, 702b provide their checkpoint key shares for decryption within the final secure multi-party computation protocol instance 704c. The final secure multi-party computation protocol instance 704c decrypts the checkpoint data, adds the private input value from the eighth computer 702e to the sum and count, and computes a final average by dividing the sum by the count to produce a computation result.

Because decryption of checkpoint data stored in checkpoint storage 706 requires checkpoint key shares held by the key holder computers 702a, 702b, the protocol 700 remains secure provided that fewer than all key holder computers collude. For SMPC protocols requiring O(N²) communication where N is the total party count, this partitioned approach with reduced party participation per partition provides significant performance improvement compared to standard protocols where all participating computers must participate throughout the entire computation. For the illustrated example with eight participating parties and a checkpoint key share count of two, the partitioned approach provides a speedup factor of over seven times compared to the standard approach of FIG. 6. To be sure, there can be fewer or more participating parties than those illustrated in FIG. 7.

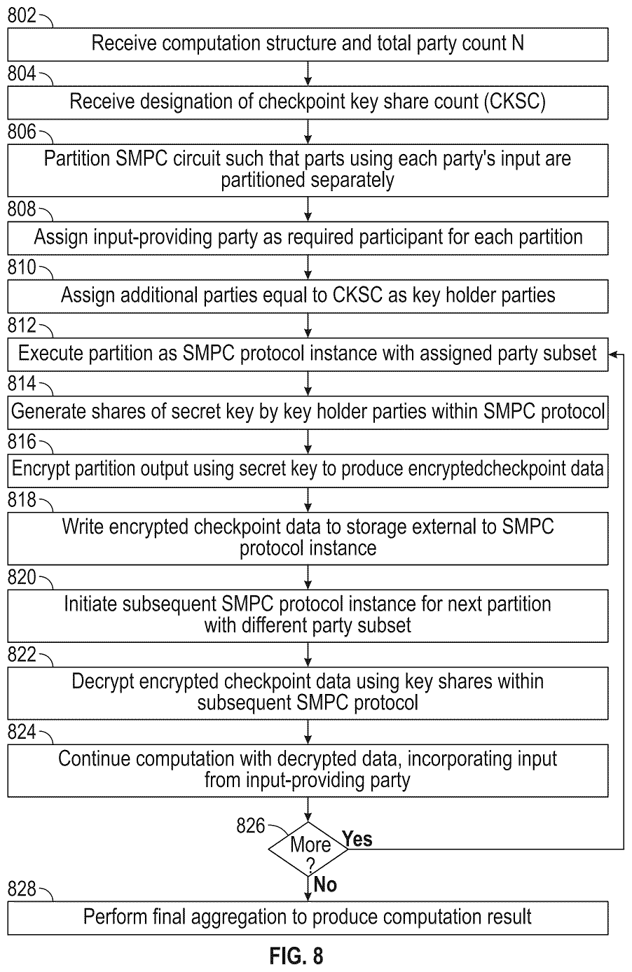

FIG. 8 is a flowchart of an example method 800 for reducing party count in many-party secure multi-party computations. The method 800 enables SMPC protocols involving three or more participating parties to execute faster by reducing the number of parties involved in any individual partition, with a configurable trade-off between performance and collusion resistance.

In some embodiments, the method 800 includes a step 802 of receiving a computation structure and a total party count N representing the number of participating parties that will contribute private input values to the computation. The computation structure specifies the type of computation to be performed, such as an aggregation function, analytics operation, or machine learning computation.

In various embodiments, the method 800 includes a step 804 of receiving a designation of a checkpoint key share count (CKSC). The checkpoint key share count is a user-configurable parameter that determines the number of key holder parties that will participate in each partition. A higher checkpoint key share count provides greater collusion resistance at the cost of reduced performance, while a lower checkpoint key share count provides improved performance with reduced collusion resistance.

In one embodiment, the method 800 includes a step 806 of partitioning an overall SMPC circuit into multiple partitions such that parts of the circuit that directly use each party's private input value are partitioned separately from one another. In some embodiments, each partition receives input from only one participating party. The remaining portions of the circuit may be partitioned arbitrarily.

In some embodiments, the method 800 includes a step 808 of assigning, for each partition requiring input from a participating party, that party as a required participant in the partition. The input-providing party must participate in the partition to contribute its private input value.

According to some embodiments, the method 800 includes a step 810 of assigning additional parties equal to the checkpoint key share count as key holder parties for the partition. The total number of parties per partition is thereby reduced from N to one plus the checkpoint key share count, expressed as (1+CKSC).

In various embodiments, the method 800 includes a step 812 of executing the partition as an SMPC protocol instance with the assigned party subset comprising the input-providing party and the key holder parties.

In one embodiment, the method 800 includes a step 814 of generating, by the key holder parties within the SMPC protocol instance, shares of a secret key. Each key holder party generates and retains a respective checkpoint key share. The key share generation occurs as part of the partition's SMPC protocol execution.

In some embodiments, the method 800 includes a step 816 of encrypting a partition output using the secret key to produce encrypted checkpoint data. In various embodiments, the encryption comprises authenticated encryption to ensure the encrypted checkpoint data has not been tampered with since creation. In some embodiments, the encryption standard comprises AES or another suitable at-rest encryption protocol.

According to various embodiments, the method 800 includes a step 818 of writing the encrypted checkpoint data to storage external to the SMPC protocol instance. At this stage, the system temporarily leaves the SMPC protocol, and the encrypted checkpoint data is protected by at-rest encryption using the shared secret key.

In one embodiment, the method 800 includes a step 820 of initiating a subsequent SMPC protocol instance for a next partition with a different party subset. The subsequent party subset includes the key holder parties that hold the checkpoint key shares needed for decryption, along with a different input-providing party that will contribute a private input value to the next partition.

In some embodiments, the method 800 includes a step 822 of decrypting, within the subsequent SMPC protocol instance, the encrypted checkpoint data using the checkpoint key shares from the key holder parties. Because the decryption occurs inside the SMPC protocol instance, and the checkpoint key shares are held by multiple key holder parties, the encrypted checkpoint data cannot be accessed unless all key holder parties participate.

In various embodiments, the method 800 includes a step 824 of continuing the computation with the decrypted data as input, incorporating the private input value from the input-providing party of the current partition.

At step 826, the method 800 determines whether additional partitions remain to be processed. If additional partitions remain (Yes), the method 800 returns to step 812 to execute the next partition as an SMPC protocol instance with an assigned party subset comprising the next input-providing party and the key holder parties. If no additional partitions remain (No), the method 800 proceeds to step 828. At step 828, following a determination at step 826 that no additional partitions remain, the method 800 performs a final aggregation to produce a computation result.

In some embodiments, the key holder parties remain the same across all partitions. In alternative embodiments, the method 800 rotates the set of key holder parties through all available participating parties as different partitions are executed. In such embodiments, each partition may have an input key holder set that decrypts incoming encrypted checkpoint data and an output key holder set that encrypts outgoing partition output. The output key holder set of a given partition participates in the subsequent partition as the input key holder set, ensuring continuity of decryption capability while distributing checkpoint key shares across different participating parties.

For SMPC protocols requiring O(N²) communication where N is the total party count, the method 800 reduces communication complexity to O((1+CKSC)²), providing significant performance improvement compared to standard protocols where all N participating parties must participate throughout the entire computation.

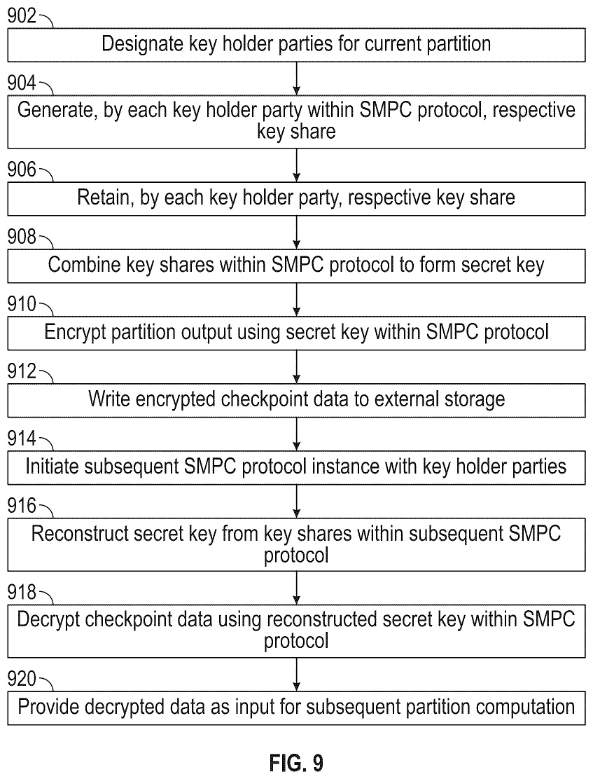

FIG. 9 is a flowchart of an example method 900 for checkpoint key share generation and management within a secure multi-party computation protocol. The method 900 provides detail on the cryptographic operations performed by key holder parties to protect intermediate computation data between partitions.

In some embodiments, the method 900 includes a step 902 of designating key holder parties for a current partition. The key holder parties are selected from among the participating parties and are responsible for generating and maintaining shares of a secret key used to protect checkpoint data. The number of key holder parties equals the checkpoint key share count.

In various embodiments, the method 900 includes a step 904 of generating, by each key holder party within the SMPC protocol, a respective key share. The key share generation occurs as part of the partition's SMPC protocol execution such that no single party has access to the complete secret key. Each key holder party generates its share independently within the secure computation environment.

In one embodiment, the method 900 includes a step 906 of retaining, by each key holder party, its respective key share. Each key holder party stores its key share for use in subsequent decryption operations. Because the shares are distributed among multiple parties, no individual party possesses sufficient information to reconstruct the secret key independently.

In some embodiments, the method 900 includes a step 908 of combining the key shares within the SMPC protocol to form the secret key. The combination occurs inside the secure computation environment such that the complete secret key is never exposed to any individual party outside the SMPC protocol context.

According to some embodiments, the method 900 includes a step 910 of encrypting the partition output using the secret key within the SMPC protocol. The encryption produces encrypted checkpoint data that can be written to external storage without revealing the underlying computation results. In various embodiments, the encryption comprises authenticated encryption using AES or another suitable at-rest encryption standard.

In various embodiments, the method 900 includes a step 912 of writing the encrypted checkpoint data to external storage. At this stage, the system exits the current SMPC protocol instance. The encrypted checkpoint data is protected by at-rest encryption and cannot be decrypted without participation of all key holder parties.

In one embodiment, the method 900 includes a step 914 of initiating a subsequent SMPC protocol instance with the key holder parties. The subsequent SMPC protocol instance is initiated for a next partition, and all key holder parties must participate to enable decryption of the checkpoint data.

In some embodiments, the method 900 includes a step 916 of reconstructing the secret key from the key shares within the subsequent SMPC protocol. Each key holder party provides its respective key share within the subsequent SMPC protocol instance, and the shares are combined to reconstruct the secret key. The reconstruction occurs inside the secure computation environment, ensuring that the complete secret key is never exposed outside the SMPC protocol context.

According to various embodiments, the method 900 includes a step 918 of decrypting the checkpoint data using the reconstructed secret key within the SMPC protocol. The decryption occurs within the subsequent SMPC protocol instance, revealing the intermediate computation results only within the secure computation environment.

At step 920, the method 900 provides the decrypted data as input for subsequent partition computation. The decrypted data serves as input for continued computation in the subsequent partition, enabling the overall SMPC computation to proceed with the next input-providing party.

The method 900 ensures that checkpoint data remains cryptographically protected at all times when outside the SMPC protocol execution context. Because the shares of the secret key are held by multiple key holder parties, the encrypted checkpoint data cannot be accessed unless all key holder parties participate in the subsequent SMPC protocol instance. This property ensures that the checkpoint data cannot be decrypted unless all holders of the key shares collude.

In some embodiments, the same key holder parties are designated for all partitions throughout the protocol execution. In alternative embodiments, the method 900 rotates the set of key holder parties through all available participating parties as different partitions are executed. In such embodiments, each partition may have an input key holder set that provides key shares for decrypting incoming checkpoint data and an output key holder set that generates key shares for encrypting outgoing checkpoint data. The output key holder set of a given partition participates in the subsequent partition as the input key holder set, ensuring continuity of decryption capability while distributing key share custody across different participating parties.

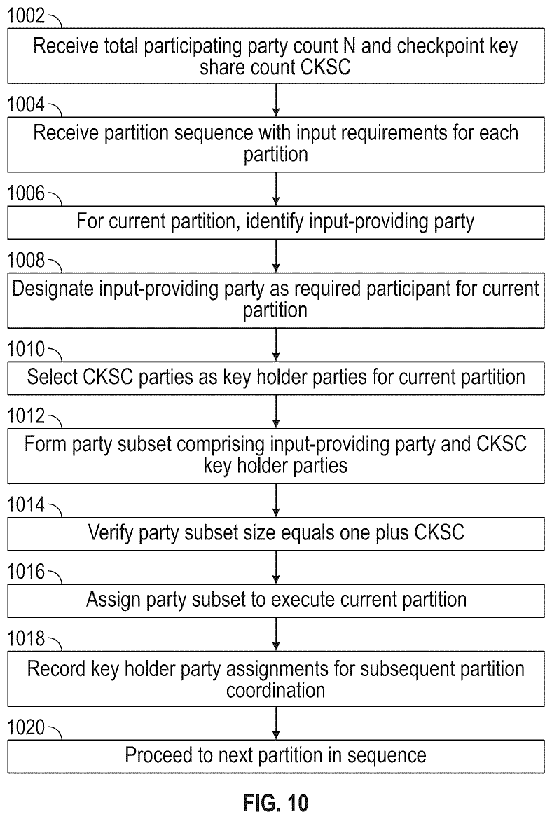

FIG. 10 is a flowchart of an example method 1000 for assigning parties to partition execution within a secure multi-party computation protocol. The method 1000 provides detail on how the system reduces the number of participating parties for each partition from the total party count N to a smaller subset of size (1+CKSC).

In some embodiments, the method 1000 includes a step 1002 of receiving the total participating party count N and the checkpoint key share count (CKSC). The party count N represents all parties that will provide input to the overall computation. The CKSC represents the number of additional parties beyond the input-providing party that will hold shares of the checkpoint encryption key.

In various embodiments, the method 1000 includes a step 1004 of receiving the partition sequence with input requirements for each partition. Each partition in the sequence is associated with a specific party whose input is required for that partition. The partitioning ensures that parts of the circuit that directly use each party's input are partitioned separately from one another.

In one embodiment, the method 1000 includes a step 1006 of identifying, for the current partition, the input-providing party. The input-providing party is the party whose secret input data is incorporated into the computation during the current partition.

In some embodiments, the method 1000 includes a step 1008 of designating the input-providing party as a required participant for the current partition. The input-providing party must participate in the partition because the partition directly uses that party's input data.

According to some embodiments, the method 1000 includes a step 1010 of selecting CKSC parties as key holder parties for the current partition. The key holder parties are selected from among the participating parties and are responsible for generating and holding shares of the secret key used to encrypt checkpoint data. The selection may be performed randomly or according to predetermined criteria such as network bandwidth or computational capabilities.

In various embodiments, the method 1000 includes a step 1012 of forming a party subset comprising the input-providing party and the CKSC key holder parties. The party subset represents all parties that will participate in executing the current partition.

In one embodiment, the method 1000 includes a step 1014 of verifying that the party subset size equals one plus CKSC. This verification ensures that the number of parties involved in the partition is reduced from the total party count N to the smaller value (1+CKSC), thus reducing the communication overhead associated with the SMPC protocol.

In some embodiments, the method 1000 includes a step 1016 of assigning the party subset to execute the current partition. The assigned party subset executes the partition using the SMPC protocol, with the reduced party count resulting in reduced communication complexity.

According to various embodiments, the method 1000 includes a step 1018 of recording the key holder party assignments for subsequent partition coordination. The key holder party identities are recorded so that subsequent partitions can require participation of these parties for checkpoint decryption.

At step 1020, the method 1000 proceeds to the next partition in the sequence. The method 1000 is repeated for each partition, with the input-providing party changing according to the partition sequence while the key holder parties may remain static or rotate through the available parties.

In some embodiments, the key holder parties remain static across all partitions. In such embodiments, the same CKSC parties are assigned as key holder parties for every partition in the sequence, ensuring consistent key share custody throughout the protocol execution.

In alternative embodiments, the method 1000 rotates the set of key holder parties through all available participating parties as different partitions are executed. In such embodiments, each partition may have an input key holder set and an output key holder set. The input key holder set comprises parties that hold key shares for decrypting incoming checkpoint data from the previous partition. The output key holder set comprises parties that hold key shares for encrypting outgoing checkpoint data for the next partition. The output key holder set of a given partition becomes the input key holder set for the subsequent partition, ensuring continuity of decryption capability.

In various embodiments where key holder rotation is employed, the method 1000 ensures that sufficient overlap exists between consecutive partition participants to enable checkpoint data transfer. The input key holder parties from the previous partition must participate in the current partition to provide their key shares for decrypting the incoming checkpoint data.

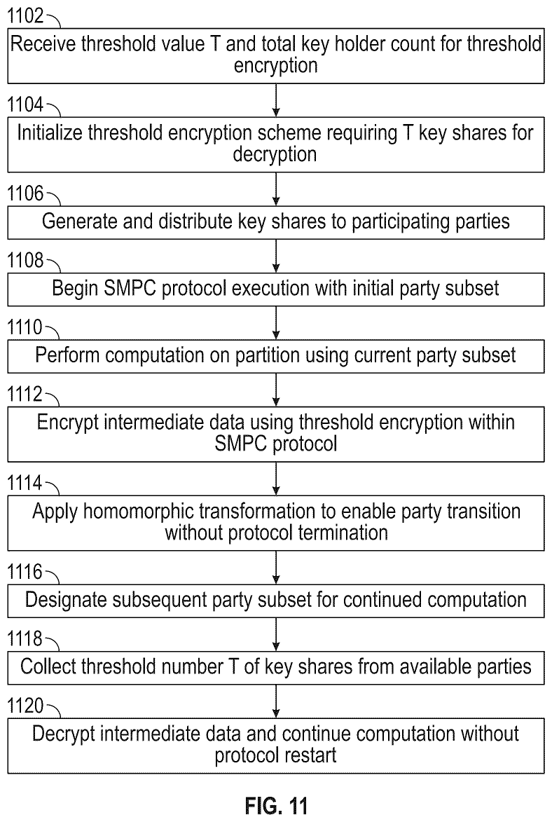

FIG. 11 is a flowchart of an example method 1100 for an alternative embodiment using threshold encryption to enable party transitions without protocol termination. The method 1100 provides an alternative to the checkpoint-based approach described in FIGS. 8-10, where a party subset changes occur mid-protocol using threshold encryption and homomorphic transformations rather than explicit protocol restart cycles.

In some embodiments, the method 1100 includes a step 1102 of receiving a threshold value T and a total key holder count for threshold encryption. The threshold value T specifies the minimum number of key shares required to decrypt intermediate data. Unlike the checkpoint approach where all key holder parties must participate in decryption, threshold encryption allows decryption when any T of the total key holders provide their shares.

In various embodiments, the method 1100 includes a step 1104 of initializing a threshold encryption scheme requiring T key shares for decryption. The threshold encryption scheme is configured such that intermediate computation data can be encrypted using all key shares but decrypted using only T key shares. This property enables flexibility in which parties participate in subsequent computation stages.

In one embodiment, the method 1100 includes a step 1106 of generating and distributing key shares to participating parties. Each participating party receives a key share that can contribute to decryption operations. The total number of key shares distributed may exceed the threshold T, providing redundancy and flexibility in party participation.

In some embodiments, the method 1100 includes a step 1108 of beginning SMPC protocol execution with an initial party subset. The initial party subset executes the first portion of the computation within the SMPC protocol context.

According to some embodiments, the method 1100 includes a step 1110 of performing computation on a partition using the current party subset. The current party subset executes the assigned partition within the ongoing SMPC protocol instance.

In various embodiments, the method 1100 includes a step 1112 of encrypting intermediate data using threshold encryption within the SMPC protocol. The intermediate computation results are encrypted using the threshold encryption scheme, producing ciphertext that can be decrypted by any T key holders.

In one embodiment, the method 1100 includes a step 1114 of applying a homomorphic transformation to enable party transition without protocol termination. Homomorphic encryption enables computation on encrypted data without requiring decryption. The homomorphic transformation prepares the encrypted intermediate data for handoff to a different party subset while maintaining the security properties of the SMPC protocol.

In some embodiments, the method 1100 includes a step 1116 of designating a subsequent party subset for continued computation. The subsequent party subset may comprise different parties than the initial subset, with the constraint that at least T parties capable of providing key shares must participate.

According to various embodiments, the method 1100 includes a step 1118 of collecting the threshold number T of key shares from available parties. The method collects key shares from T parties, which may include parties from the previous subset, parties from the subsequent subset, or a combination thereof.

At step 1120, the method 1100 decrypts the intermediate data and continues computation without protocol restart. The decryption occurs within the SMPC protocol context using the T collected key shares, and computation proceeds with the subsequent party subset. Unlike the checkpoint approach, no explicit protocol termination and restart occurs between partitions.

The method 1100 offers an alternative to the checkpoint-based approach described in FIGS. 8-10. In the checkpoint approach, the SMPC protocol terminates between partitions, encrypted checkpoint data is written to external storage, and a new SMPC protocol instance is initiated for the subsequent partition. In the threshold encryption approach of method 1100, the SMPC protocol execution continues without termination, with party transitions occurring mid-protocol through homomorphic transformations.

In some embodiments, the threshold encryption approach provides advantages in scenarios where protocol restart overhead is significant or where continuous protocol execution is preferred. The threshold property also provides flexibility in party participation, as decryption requires only T of the total key holders rather than all key holders.

In various embodiments, the threshold encryption approach involves greater computational complexity than the checkpoint approach. The homomorphic transformations required to enable mid-protocol party transitions impose additional computational overhead. The threshold encryption and decryption operations may also be more computationally intensive than standard symmetric encryption used in the checkpoint approach.

The selection between the checkpoint approach and the threshold encryption approach may depend on factors including the relative costs of protocol restart versus homomorphic computation, the desired flexibility in party participation, and the security requirements of the specific application.

The systems and methods of the present disclosure have application across multiple industries where organizations possessing sensitive or proprietary data seek to perform joint computations without disclosing underlying data to other participants. The checkpoint key share mechanism enabling reduced party participation per partition is particularly advantageous in many-party protocols common to these industry applications, where the O(N²) communication complexity of standard SMPC protocols would otherwise render joint computation impractical.

In healthcare applications, multiple healthcare organizations such as hospitals, research institutions, insurance providers, and pharmaceutical companies may each collect protected health information containing personally identifiable information subject to privacy regulations. These organizations may wish to train machine learning models on combined patient populations to improve diagnostic accuracy, treatment efficacy predictions, or risk stratification models. The systems and methods of the present disclosure enable such organizations to jointly train machine learning models using SMPC without transmitting protected health information to one another. Each healthcare organization contributes its private patient data as input to the SMPC protocol, and the protocol produces a trained model as output without exposing any individual patient records to other participating organizations. The checkpoint key share mechanism reduces the number of parties that must simultaneously participate in each partition of the model training computation, enabling practical execution of training protocols that would otherwise be prohibitively slow due to the communication overhead associated with many-party SMPC.

In industrial control system applications, manufacturers of industrial equipment such as machinery for automotive production, semiconductor fabrication, food processing, or other manufacturing operations sell equipment to customer organizations that operate the equipment in their facilities. The equipment manufacturers seek to collect operational telemetry data from deployed equipment to monitor equipment health, predict maintenance requirements, identify failure modes, and improve future equipment designs. However, the customer organizations operating the equipment may be unwilling to transmit raw operational data to the equipment manufacturer because such data may reveal proprietary information about production volumes, manufacturing processes, product specifications, or operational practices. The systems and methods of the present disclosure enable equipment manufacturers and customer organizations to jointly compute aggregate statistics, anomaly detection models, or predictive maintenance models over combined operational data from multiple customer sites without requiring any customer organization to disclose raw operational data to the equipment manufacturer or to other customer organizations. Each customer organization contributes its private operational telemetry as input to the SMPC protocol, and the protocol produces analytical results accessible to designated parties without exposing underlying operational data.

In automotive applications, vehicles equipped with sensors and connectivity capabilities collect telemetry data including vehicle performance metrics, environmental observations, driver behavior patterns, and navigation information. Vehicle manufacturers, fleet operators, insurance providers, and transportation authorities may seek to train machine learning models on combined telemetry data from vehicle populations to improve autonomous driving systems, optimize traffic flow, enhance safety systems, or refine insurance risk models. However, vehicle owners and operators may be unwilling to transmit raw telemetry data to centralized locations due to privacy concerns or competitive sensitivities. The systems and methods of the present disclosure enable joint model training across distributed vehicle telemetry data sources without requiring centralized data collection. Each participating organization contributes private telemetry data as input to the SMPC protocol, and the protocol produces trained models or analytical results without exposing individual vehicle telemetry to other participants. The checkpoint key share mechanism is particularly advantageous in automotive applications where the number of participating data sources may be large, as the reduced party participation per partition enables practical protocol execution despite the many-party nature of the computation.

In advertising and marketing applications, distinct organizations possess complementary data relevant to advertising effectiveness measurement and optimization. Publishers and website operators possess data identifying which users have viewed content or purchased products through their platforms. Advertising networks and platforms possess data identifying which users have been shown particular advertisements. Advertisers possess data regarding campaign objectives and conversion definitions. Combining these data sources would enable measurement of advertising effectiveness by correlating advertisement exposure with subsequent user actions, identification of user segments responsive to particular advertising approaches, and optimization of advertising targeting and placement strategies. However, these organizations may be unwilling to share raw user-level data with one another due to privacy regulations, competitive concerns, or contractual restrictions. The systems and methods of the present disclosure enable joint computation of advertising effectiveness metrics, audience segmentation models, or recommendation systems across these complementary data sources without requiring any organization to disclose raw user-level data to other participants. Each organization contributes its private data as input to the SMPC protocol, and the protocol produces aggregate insights or trained models accessible to designated parties. The checkpoint key share mechanism enables practical execution of these multi-party computations by reducing communication complexity from O(N²) to O((1+CKSC)²), where N represents the total number of participating organizations and CKSC represents the checkpoint key share count.

In financial services applications, multiple financial institutions such as banks, credit unions, insurance companies, investment firms, and payment processors may seek to compute aggregate statistics, risk models, or fraud detection systems over combined customer populations. For example, multiple banks may wish to compute aggregate statistics over their joint customer populations to improve credit risk models, detect money laundering patterns, or identify fraudulent transaction sequences that span multiple institutions. However, financial institutions are prohibited by regulation and competitive interest from disclosing individual customer data to other institutions. The systems and methods of the present disclosure enable joint computation across financial institution data without requiring disclosure of customer-level information. Each financial institution contributes private customer data as input to the SMPC protocol, and the protocol produces analytical results or trained models without exposing underlying customer records. The collusion resistance provided by the checkpoint key share mechanism ensures that intermediate computation results remain protected unless all designated key holder parties cooperate in decryption.

Where appropriate, the functions described herein can be performed in hardware, software, firmware, digital components, or analog components. For example, the encoding and decoding systems can be embodied as one or more application-specific integrated circuits (ASICs) or microcontrollers programmed to carry out the described systems and procedures. Certain terms used throughout the description and claims refer to specific system components. Components may be referred to by different names, but the document does not intend to distinguish between components that differ in name but not function.

One skilled in the art will recognize that the Internet service may be configured to provide Internet access to one or more computing devices coupled to the Internet service. These computing devices may include one or more processors, buses, memory devices, display devices, input/output devices, and the like. Additionally, the Internet service may be coupled to one or more databases, repositories, servers, and similar resources utilized to implement any of the embodiments described herein.

The corresponding structures, materials, acts, and equivalents of all means or step-plus-function elements in the claims are intended to include any structure, material, or act for performing the function in combination with other claimed elements as specifically claimed. The description of the present technology is presented for illustrative purposes and is not intended to be exhaustive or limited to the disclosed form. Many modifications and variations will be apparent to those skilled in the art without departing from the scope and spirit of the technology. Exemplary embodiments were chosen and described to best explain the principles of the technology and its practical application, enabling others to understand various embodiments with suitable modifications.

If any disclosures are incorporated herein by reference and such incorporated disclosures conflict with the present disclosure, the present disclosure controls. If such incorporated disclosures conflict with each other, the later-dated disclosure controls.

The terminology used herein can imply direct or indirect, full or partial, temporary or permanent, immediate or delayed, synchronous or asynchronous, action or inaction. For example, when an element is referred to as being “on,” “connected,” or “coupled” to another element, it can be directly on, connected, or coupled to the other element, and/or intervening elements may be present. In contrast, when an element is referred to as being “directly connected” or “directly coupled” to another element, no intervening elements are present.

The terminology used herein is for the purpose of describing particular embodiments and is not intended to be limiting. As used herein, the singular forms “a,” “an,” and “the” include plural forms unless the context clearly indicates otherwise. The terms “comprises,” “includes,” and/or “comprising,” “including” specify the presence of stated features, integers, steps, operations, elements, and/or components but do not preclude the presence or addition of one or more other features, integers, steps, operations, elements, components, and/or groups thereof.

Example embodiments of the present disclosure are described with reference to idealized illustrations. Variations from the shapes of the illustrations due to manufacturing techniques and/or tolerances are to be expected. Thus, the example embodiments should not be construed as limited to the particular shapes illustrated but include deviations resulting from manufacturing.

Aspects of the present technology are described with reference to flowchart illustrations and/or block diagrams of methods, apparatus (systems), and computer program products. Each block of the flowchart illustrations and/or block diagrams and combinations of blocks can be implemented by computer program instructions. These instructions may be provided to a processor of a general-purpose computer, special-purpose computer, or other programmable data processing apparatus to produce a machine, creating means for implementing the functions/acts specified in the flowcharts and/or block diagrams.

For explanation and not limitation, specific details are set forth, such as particular embodiments, procedures, techniques, etc., to provide a thorough understanding of the present disclosure. However, the present disclosure may be practiced in other embodiments that depart from these specific details.

Reference to “one embodiment” or “an embodiment” means that a particular feature, structure, or characteristic described in connection with the embodiment is included in at least one embodiment. The phrases “in one embodiment” or “in an embodiment” at various places are not necessarily referring to the same embodiment. Features, structures, or characteristics may be combined in any suitable manner in one or more embodiments. Depending on the context, a singular term may include its plural forms and vice versa. Similarly, hyphenated terms, capitalized terms, plural terms with or without apostrophes, and italicized terms may be used interchangeably without inconsistency.

Some embodiments may be described in terms of “means for” performing a task or set of tasks. A “means for” may include a structure, such as a processor, memory, an I/O device, or combinations thereof. Alternatively, the “means for” may include an algorithm, a mathematical formula, prose, or as a flow chart or signal diagram.

What is claimed is:

1. A method for secure multi-party computation with reduced party participation, the method comprising:
receiving, by a controller computer, a computation structure, a total party count N;
receiving, by the controller computer, a designation of a checkpoint key share count;
partitioning, by the controller computer, a secure multi-party computation circuit into a plurality of partitions such that parts of the secure multi-party computation circuit that directly use each private input value are partitioned separately from one another;
assigning, by the controller computer, a first participating party of the plurality of participating parties as an input-providing party for a first partition of the plurality of partitions;
assigning, by the controller computer, a number of additional participating parties of the plurality of participating parties equal to the checkpoint key share count as key holder parties for the first partition, where a total number of parties assigned to the first partition equals one plus the checkpoint key share count;
initiating, by the controller computer, execution of the first partition as a secure multi-party computation protocol instance with a party subset comprising the input-providing party and the key holder parties;
generating, within the secure multi-party computation protocol instance, shares of a secret key, the shares of the secret key are distributed among the key holder parties;
encrypting, by the controller computer, a partition output of the first partition using the secret key to produce encrypted checkpoint data; and writing, by the controller computer, the encrypted checkpoint data to storage external to the secure multi-party computation protocol instance.

2. The method of claim 1, further comprising: initiating, by the controller computer, a subsequent secure multi-party computation protocol instance for a second partition of the plurality of partitions with a different party subset comprising the key holder parties and a second participating party of the plurality of participating parties as a second input-providing party; and
decrypting, within the subsequent secure multi-party computation protocol instance, the encrypted checkpoint data using the shares of the secret key.

3. The method of claim 1, wherein the encrypting comprises authenticated encryption.

4. The method of claim 3, wherein the authenticated encryption comprises Advanced Encryption Standard encryption.

5. The method of claim 1, wherein the key holder parties remain the same across all partitions of the plurality of partitions.

6. The method of claim 1, further comprising rotating, by the controller computer, the key holder parties through the plurality of participating parties as different partitions of the plurality of partitions are executed.

7. The method of claim 1, further comprising:
receiving, by the controller computer, a threshold value T and a total key holder count for threshold encryption;
initializing, by the controller computer, a threshold encryption scheme requiring T key shares for decryption;
applying, within the secure multi-party computation protocol instance, a homomorphic transformation to enable party transition without protocol termination, the homomorphic transformation prepares the encrypted intermediate data for handoff to a different party subset while maintaining the security properties of the SMPC protocol; and
collecting the threshold number T of key shares from available parties.

8. A system for partitioned secure multi-party computation, the system comprising:
a plurality of computers, each computer of the plurality of computers associated with a respective participating party and configured to contribute a respective private input value to a computation;
a checkpoint storage configured to store encrypted checkpoint data; and
a controller configured to:
partition an overall secure multi-party computation circuit into a plurality of partitions, each partition of the plurality of partitions involving a party subset of the plurality of computers;
for a first partition of the plurality of partitions, designate a first computer of the plurality of computers as an input-providing computer that contributes a first private input value to the first partition and designate a plurality of key holder computers from the plurality of computers;
execute the first partition as a secure multi-party computation protocol instance with the party subset comprising the input-providing computer and the plurality of key holder computers;
generate, within the secure multi-party computation protocol instance, shares of a secret key distributed among the plurality of key holder computers; encrypt a partition output of the first partition using the secret key to produce the encrypted checkpoint data; and
write the encrypted checkpoint data to the checkpoint storage.

9. The system of claim 8, wherein the controller is further configured to:
initiate a subsequent secure multi-party computation protocol instance for a second partition of the plurality of partitions with a second party subset comprising the plurality of key holder computers and a second computer of the plurality of computers as a second input-providing computer; and
decrypt, within the subsequent secure multi-party computation protocol instance, the encrypted checkpoint data using the shares of the secret key.

10. The system of claim 8, wherein the encrypted checkpoint data comprises authenticated encryption data.

11. The system of claim 10, wherein the authenticated encryption data comprises Advanced Encryption Standard encrypted data.

12. The system of claim 8, wherein the plurality of key holder computers remains the same across all partitions of the plurality of partitions.

13. The system of claim 8, wherein the controller is further configured to rotate the plurality of key holder computers through the plurality of computers as different partitions of the plurality of partitions are executed.

14. The system of claim 8, wherein a total number of computers in the party subset equals one plus a checkpoint key share count, and wherein the checkpoint key share count equals a number of the plurality of key holder computers.

15. A method for managing checkpoint key shares in secure multi-party computation, the method comprising:
receiving, by a controller, a threshold value T and a total key holder count for threshold encryption;
initializing, by the controller, a threshold encryption scheme requiring T key shares for decryption, the threshold encryption allows decryption when any T of the total key holders provide their shares;
receiving, by the controller, a plurality of private input values from a plurality of computers;
configuring, by the controller, a secure multi-party computation protocol instance for a current partition, the configuring comprises designating a plurality of key holder computers from the plurality of computers;
initiating, by the controller, execution of the secure multi-party computation protocol instance;
applying, within the secure multi-party computation protocol instance, a homomorphic transformation to enable party transition without protocol termination, the homomorphic transformation prepares encrypted intermediate data for handoff to a different party subset while maintaining security properties of the secure multi-party computation protocol;
collecting the threshold number T of key shares from available parties; and
decrypting, within the secure multi-party computation protocol instance, the intermediate data and continuing computation without protocol restart.

16. The method of claim 15, further comprising providing, by the controller, the decrypted intermediate data as input for continued computation with a subsequent party subset.

17. The method of claim 15, further comprising encrypting, within the secure multi-party computation protocol instance, intermediate computation results using the threshold encryption scheme, producing ciphertext that can be decrypted by any T key holders.

18. The method of claim 17, wherein the threshold encryption scheme is configured such that intermediate computation data can be encrypted using all key shares but decrypted using only T key shares.

19. The method of claim 15, wherein the collecting comprises collecting key shares from T parties, which may include parties from a previous party subset, parties from the subsequent party subset, or a combination thereof.

20. The method of claim 15, further comprising designating, by the controller, a subsequent party subset for continued computation, wherein the subsequent party subset may comprise different parties than an initial party subset.
